(19) United States
(12) Patent Application Publication
(10) Pub. No.: US 2009/0002386 A1
(43) Pub. Date: Jan. 1, 2009

(54) Graphical Representation Creation Mechanism

(75) Inventors: Julien Jacques Jalon, Paris (FR); Julien Yann Robert, Paris (FR); Toby Charles Wood Paterson, Paris (FR)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 11/771,928

(22) Filed: Jun. 29, 2007

(51) Int. Cl. G09G 5/00

(52) U.S. Cl. 345/581

(57) ABSTRACT

Methods, systems, and apparatus, including computer program products, for generating graphical representations. An image representing an item is obtained. Input specifying one or more styles is obtained. For a style, one or more graphical effects are identified based on the style. A layout is generated, including applying the style including the graphical effects to the image based on one or more layout rules. A graphical representation corresponding to the item is generated using the layout. Metadata associated with the layout is generated. The metadata includes data indicating a location of the image in the layout.

### BACKGROUND

The subject matter of this specification relates generally to graphical user interfaces.

In a user interface of a computer system or other electronic device, files can be represented by graphical representations (e.g., a document icon as representative of a particular document file). With some operating systems, the user interface can provide previews of file contents. One conventional way to provide a preview of file contents is to present a graphical representation in the user interface that combines a small thumbnail image and one or more other graphical elements that represent the contents of the file.

### SUMMARY

In general, one aspect of the subject matter described in this specification can be embodied in methods that include the actions of obtaining an image representing an item; obtaining input specifying one or more styles; identifying, for a style, one or more graphical effects based on the style; generating a layout, including applying the style including the graphical effects to the image based on one or more layout rules; generating a graphical representation corresponding to the item using the layout; and generating metadata associated with the layout, the metadata including data indicating a location of the image in the layout. Other embodiments of this aspect include corresponding systems, apparatus, and computer program products.

Particular embodiments of the subject matter described in this specification can be implemented to realize one or more of the following advantages. Icons corresponding to a file type can be associated with an icon style that can provide a representation or hint of the content of the file. Various graphical elements can be arranged in a layout with an image (e.g., a thumbnail image) to generate an icon for the file that will not distort when operated on by other applications (e.g., a preview application). An icon of a file can include metadata describing the location of the image in the layout. Processes can use the icon metadata to extract the image from the icon and perform operations on the image without distorting the graphical elements that surround the image.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example of a system architecture for generating and presenting icons for data items.

FIGS. 2A-2D illustrate an example user interface for previewing and creating icon styles.

FIG. 3 is a block diagram illustrating an example architecture for generating icons for data items.

FIG. 4 is a flow diagram illustrating an example process for generating icons for data items.

Like reference numbers and designations in the various drawings indicate like elements.

### DETAILED DESCRIPTION

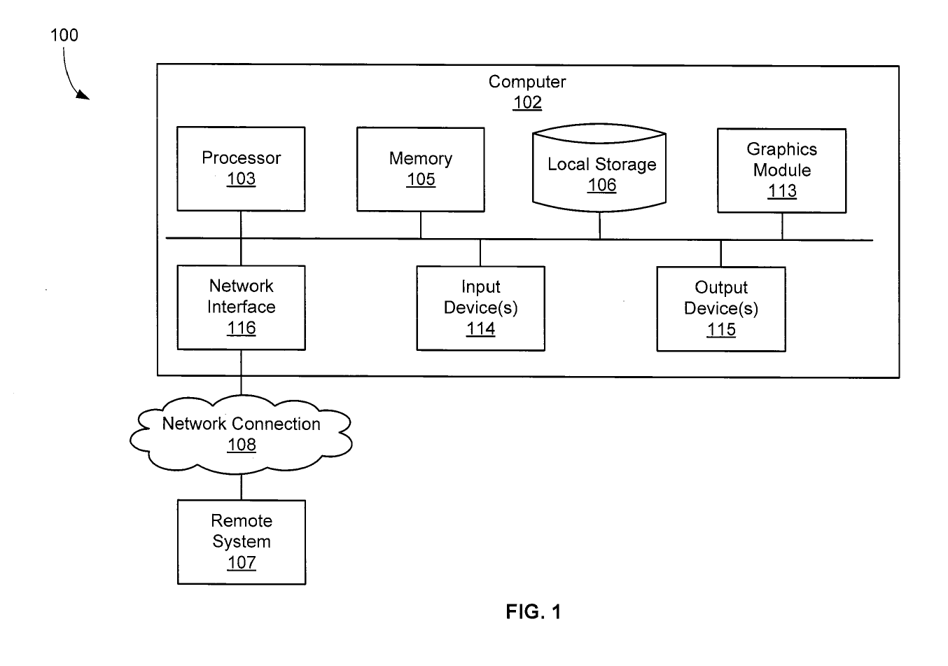

FIG. 1 is a block diagram of an architecture 100 for generating graphical representations (hereinafter referred to generically as “icons”) that provide visual hints to the type and/or content of data items, such as files, associated therewith. The architecture 100 includes a personal computer 102. The computer 102 is optionally communicatively coupled to a remote server 107 using a network interface 116 and a network 108 (e.g., local area network, wireless network, Internet, intranet, etc.). The computer 102 generally includes a processor 103, memory 105, one or more input devices 114 (e.g., keyboard, mouse, etc.) and one or more output devices 115 (e.g., a display device). A user interacts with the architecture 100 using the input and output devices 114 and 115, respectively. Architecture 100 can include hardware, software, and combinations of the two.

The computer 102 also includes a local storage device 106 and a graphics module 113 (e.g., graphics card) for storing information and generating graphical objects, respectively. The local storage device 106 can be a computer-readable medium. The term “computer-readable medium” refers to any medium that includes data and/or participates in providing instructions to a processor for execution, including without limitation, non-volatile media (e.g., optical or magnetic disks), volatile media (e.g., memory) and transmission media. Transmission media includes, without limitation, coaxial cables, copper wire, fiber optics, and computer buses. Transmission media can also take the form of acoustic, light or radio frequency waves.

While generating icons that provide visual hints to the type and/or content of data items therein are described with respect to a personal computer 102, it should be apparent that the disclosed implementations can be incorporated in, or integrated with, any electronic device that has a user interface, including without limitation, portable and desktop computers, servers, electronics, media players, game devices, mobile phones, smart phones, email devices, personal digital assistants (PDAs), embedded devices, televisions, other consumer electronic devices, etc.

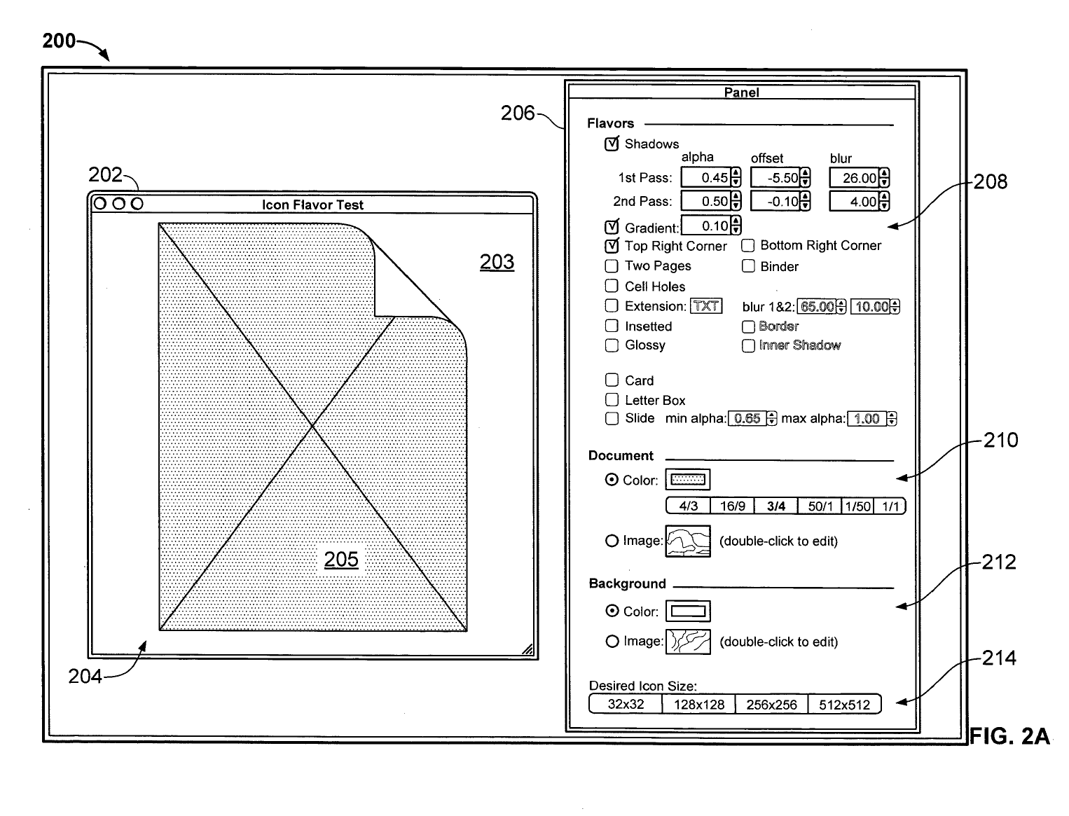

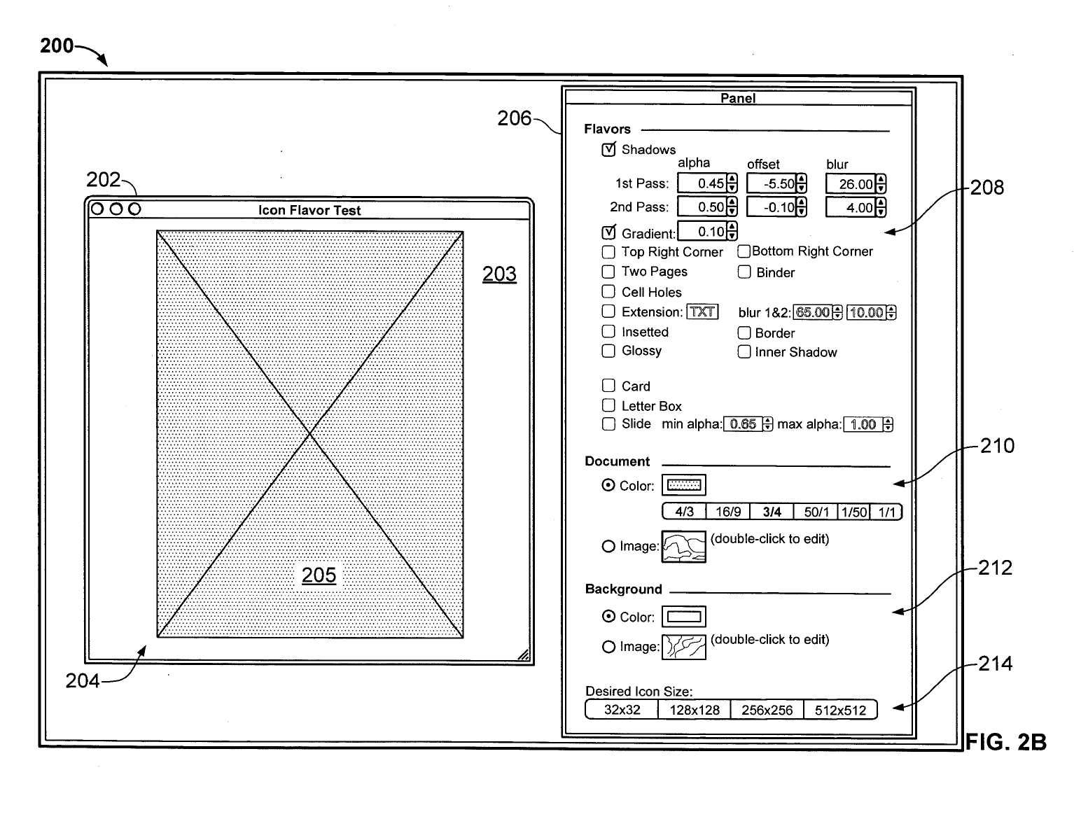

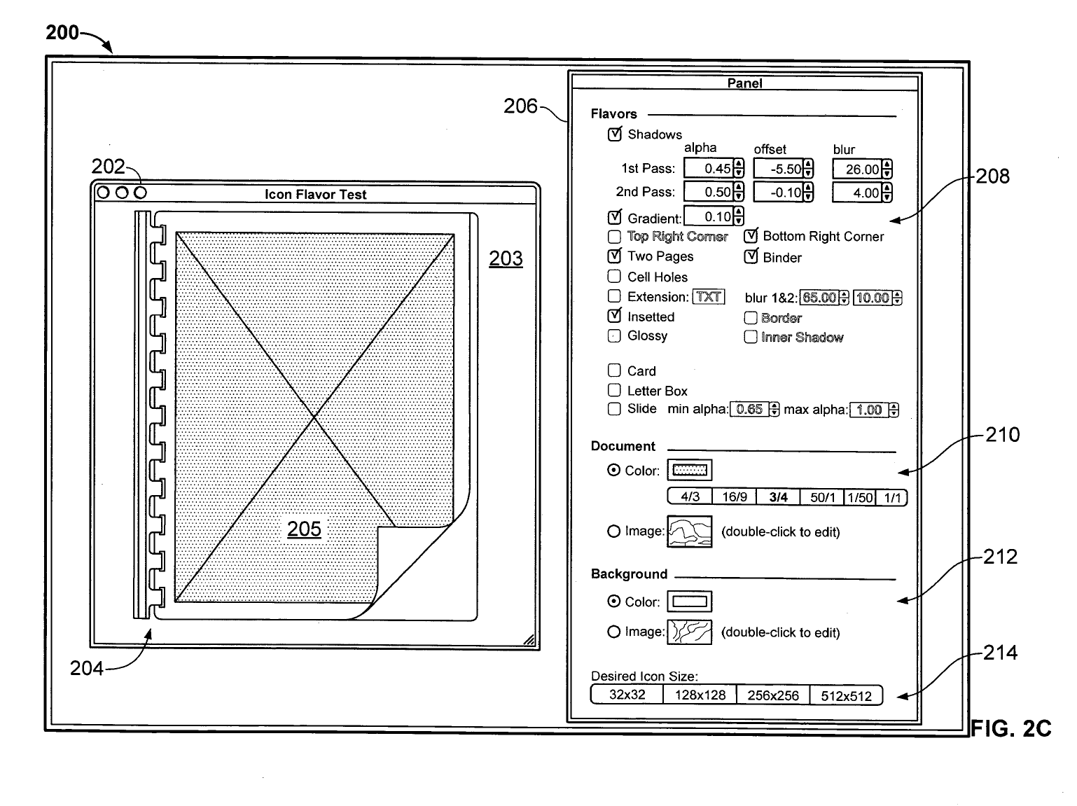

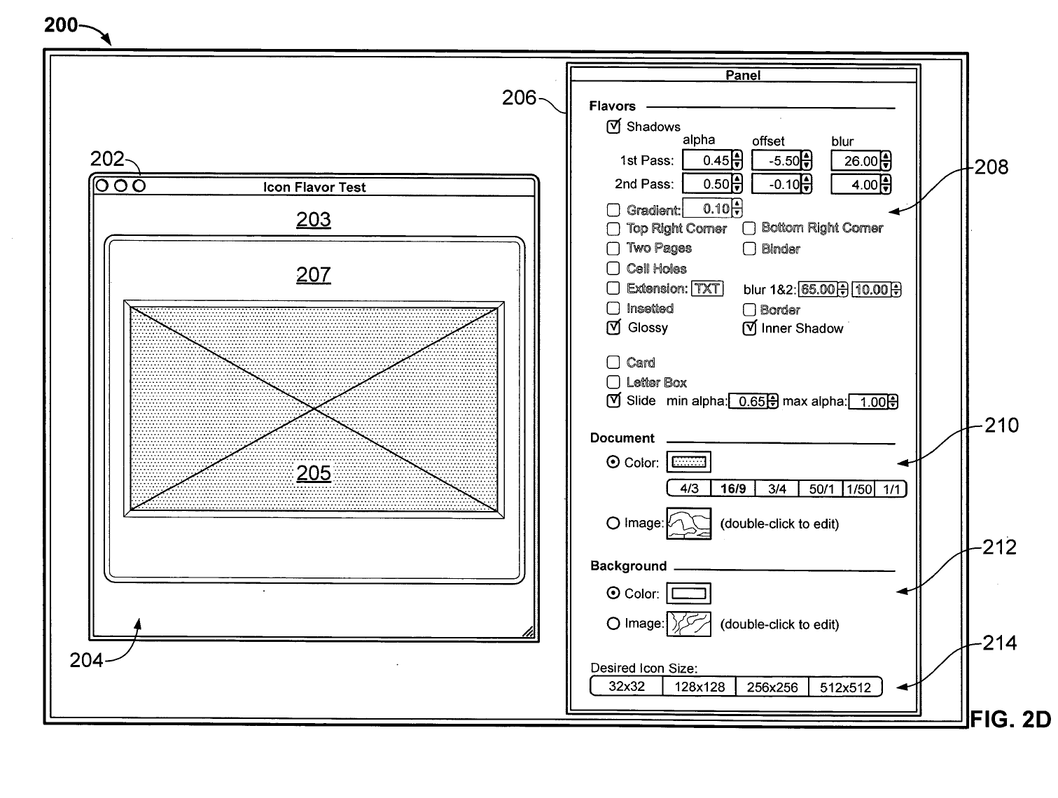

One of ordinary skill in the art will recognize that the engines, methods, processes and the like that are described can themselves be an individual process or application, part of an operating system, a plug-in, an application, or the like. In one implementation, the system and methods can be implemented as one or more plug-ins that are installed and run on the personal computer 102. The plug-ins are configured to interact with an operating system (e.g., MAC OS X, WINDOWS XP, WINDOWS VISTA, LINUX, etc.) and to perform the various functions, as described with respect to FIGS. 2-4. A system and method for generating icons that provide visual hints to the type and/or content of associated data items can also be implemented as one or more software applications running on the computer 102. Such a system and method can be characterized as a framework or model that can be implemented on various platforms and/or networks (e.g., client/server networks, wireless networks, stand-alone computers, portable electronic devices, mobile phones, etc.), and/or embedded or bundled with one or more software applications (e.g., email, media player, browser, etc.).

The computer 102 can store data items, such as files and other data objects, in the local storage device 106, for example. Examples of data items include documents, images or graphics, video clips, audio clips, and so forth. The data items can be classified into various types. In some implementations, the types to which the data items can be classified are specified by a Uniform Type Identifier (UTI) defined by APPLE, INC. In some other implementations, the types to which the data items can be classified are specified by file extensions or Multipurpose Internet Mail Extensions (MIME).

In some implementations, the computer 102 includes one or more item viewing modules, programs, processes, or the like. The item view module includes a user interface where a user can browse for items (e.g., files, folders) stored in or accessible by the computer 102. In some implementations, a visual preview of a item can be generated for presentation to the user by the item viewing module. The visual preview gives the user an indication of the content of the item. In an example implementation, the preview can be a thumbnail image of the item or a view of the item within a viewer of a user interface of the item viewing module. The preview viewer user interface presents the item and can include controls for manipulating the item or the preview of the item. For example, the preview viewer can present a zoomed out view of a document and provide controls for the user to navigate between pages of the document.

A thumbnail of the item can be an image that depicts the content of the item. For example, a thumbnail of a word processing document can be an image depicting the first page of the document. As another example, the thumbnail of a video clip can be a sample frame of the video clip (e.g., the first frame of the video). As a further example, the thumbnail of an image can be a scaled down version of the image.

In some implementations, an icon can be generated from a representation (e.g., a thumbnail) of an item. For the purposes of this disclosure, reference is made to a representation of the form of a thumbnail. Other forms of representations are possible. The icon can be a graphical object that can provide a visual hint of the type of the item (e.g., a file type) and depict the contents of the item (e.g., image, video, text).

The icon can be presented to the user in the user interface of an item viewing module. In one implementation, the icon includes the thumbnail of the item (e.g., a data item) and one or more graphical effects applied to the thumbnail. The graphical effects that are applied to the thumbnail can be specified by an icon style. An icon style can serve as a template that specifies the graphical effects that are to be applied to a thumbnail. In some implementations, each type of item is associated with a particular icon style. Thus, for example, text documents can be associated with a particular icon style, and video clips can be associated with another (e.g., different) icon style. In an example implementation, for an item type identified by a particular UTI, an icon style associated with the type can be an attribute of the particular UTI.

FIGS. 2A-2D illustrate an example user interface 200 for previewing and creating icon styles. An icon style can be created by a developer and associated with an item type. The user interface 200 includes an icon preview window 202 and an options panel 206. The options panel 206 includes one or more options for configuring an icon style. The icon preview window 202 presents a sample rendering (e.g., icon style preview 204) of an icon style based on the options selected in the options panel 206.

In some implementations, an icon style preview 204 includes a background 203 and a composite graphic 205 over the background. The composite graphic 205 can be formed by applying one or more graphical effects (heretofore also referred to as “flavors”) to a test graphic (e.g., an image, a shape filled with a specified color). A graphical effect or flavor, when applied to a thumbnail, can modify the appearance of the thumbnail in some way.

The options panel includes flavor options 208, document or item options 210, background options 212, and icon size 214. In some implementations, the flavor options 208 include one or more options for various flavors to be applied to a test graphic to form the composite graphic 205 or changing various characteristics of the test graphic. Examples of flavors include, without limitation, shadows, a gradient effect, a folded-in corner, a binder-like side, a slide frame, cell holes that resemble perforations on the sides of photographic film, a letterboxing effect, a gloss effect, an insetting effect, text indicating a file extension, blurring effects, etc.

In some implementations, the document options 210 includes an option of thumbnail aspect ratios (e.g., 4/3, 16/9. 3/4, etc.). The document options 210 can also include an option to select a color, shading, or an image. These document options 210 allow the developer to preview an icon style with test graphics of various colors, aspect ratios, or images. For example, a icon style can be rendered with a test graphic includes a shape (e.g., a rectangle) filled with a selected color. As another example, the developer can choose a specific image as the test graphic. As a further example, an icon style can be rendered with test graphics of various aspect ratios when a specific test graphic image is not specified. The background options 212 include an option to select a background color or image for the icon style. The icon size 214 includes possible sizes for the icon. In some implementations, an icon has square dimensions.

FIG. 2A illustrates an example icon style preview 204 rendered in accordance with icon options selected in the options panel 206. The icon preview 204 shows how an icon style may be rendered and presented given the selected options. In FIG. 2A, the selected flavor options include shadows, a gradient effect, and a folded-in top right corner. The test graphic options include a 3:4 aspect ratio and a shape filled with the selected color. A color is selected for the background. The icon style preview 204, as shown in FIG. 2A, reflects the selected options and shows a composite graphic 205 having, among other things, a folded-in top right corner and shadow effects along one or more of its sides.

In FIG. 2B, the same options are selected from the options panel 206 as in FIG. 2A, except that the folded-in top right corner flavor option is not selected. The icon style preview 204 in FIG. 2B shows the difference caused by the non-selection of the corner option; the composite graphic 205 in FIG. 2B does not have a folded-in top right corner.

In FIG. 2C, the selected flavor options include shadows, a gradient effect, a folded-in bottom right corner, a binder side, a 2-page look (“two pages”), and an insetting of the test graphic. Test graphic options include a 3:4 aspect ratio and a shape filled with a selected color. A color is selected for the background. The icon style preview 204, as shown in FIG. 2C, shows a composite graphic 205 insetted into a page with a folded-in bottom right corner, with another page underneath, and with a binder-like left side.

In FIG. 2D, the selected flavor options include (outer) shadows, an inner shadow, a glossy effect, and a slide frame. The selected test graphic options include a 16:9 aspect ratio and a shape filled with the selected color. A color is selected for the background. The icon style preview 204, as shown in FIG. 2D, shows, among other things, a composite graphic 205 framed by a slide frame 207.

The developer can save the selected flavor options, background options, and icon size as an icon style. In some implementations, the selected options for an icon style are specified in a data object (e.g., a data file, a value stored in memory) that specifies which options were selected or are active in the icon style. In some implementations, the data object includes a bit field that indicates the activation or deactivation of a graphical effect (e.g., shadows, gloss, slide frame, etc.) in an icon style. The data object can also include values for any graphical effect that requires a magnitude or degree (e.g., amount of shadow, width of slide frame, etc.) and values related to the background and icon size.

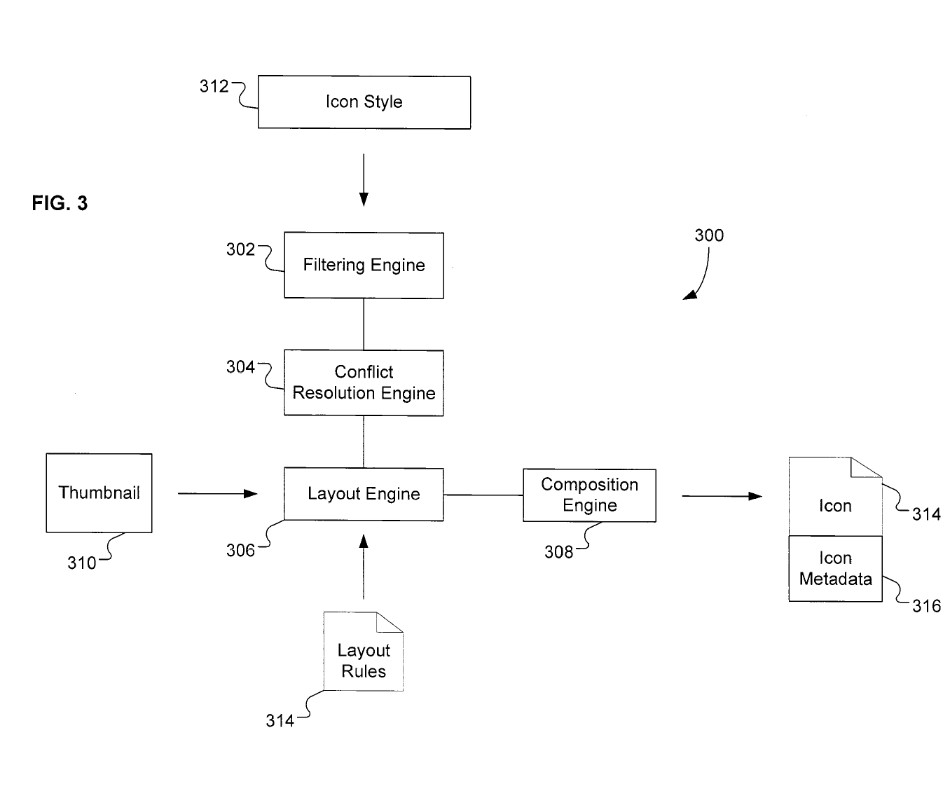

FIG. 3 is a block diagram illustrating an example architecture 300 for generating icons for items. In some implementations, the architecture 300 can be implemented in a computer 102 as hardware, software, or a combination of software and hardware. In some implementations, the architecture 300 includes an optional filtering engine 302, an optional conflict resolution engine 304, a layout engine 306, and a composition engine 308. In other implementations, one or more of the engines 302-308 can be included in a single engine, module or subsystem. In some implementations, the architecture 300 receives a thumbnail 310 of an item and one or more icon styles associated with the type of the item 312 as inputs.

The layout engine 306 generates a layout of a graphical representation corresponding to the item represented by a thumbnail 310, which includes applying graphical effects, as specified by the icon style 312, to the thumbnail 310 based on one or more layout rules 314. In some implementations, applying a graphical effect includes layering the thumbnail and one or more graphical elements corresponding to the graphical effect. For example, applying a folded-in corner effect can include overlaying the thumbnail with a graphical layer that includes the folded-in corner element at one corner and transparency or empty space in the rest of the layer. The layout rules 314 can include rules for the positioning of the elements and the thumbnail within an layout; the layout rules specify where an element and a thumbnail should be positioned within an icon. For example, a layout rule for letterboxing can specify that the thumbnail be centered between two black bars.

In some implementations, the filtering engine 302 and the conflict resolution engine 304 can process the icon style 302 before the icon style 302 is received by the layout engine 306. The filtering engine 302 filters incompatible graphical effects from the icon style. In some implementations, a particular item viewing module may present icons corresponding to items in particular ways. For example, a item viewing module may render and present a three-dimensional (3D) rendition of an icon. In some implementations, some graphical effects in icons are incompatible with a 3D rendering. For example, some graphical effects may be less aesthetically pleasing when rendered and presented in 3D. The optional filtering engine 302 includes information regarding which graphical effects are incompatible with particular renderings (e.g., 3D) used by particular applications or modules. The filtering engine 302 can identify the activated graphical effects in the icon style 312, and deactivate or disregard the graphical effects in the icon style that are incompatible with particular renderings; the incompatible graphical effect is removed from the set of activated graphical effects. The deactivation can be saved to the icon style, changing the icon style, or be a one-time deactivation effective for the particular thumbnail 310.

In some implementations, the conflict resolution engine 302 identifies conflicting graphical effects within the icon style and resolves the conflicts. For example, an icon style may have a folded-in corner and a slide frame, which may conflict with each other. As another example, an activated top-right folded-in corner conflicts with an activated bottom-right folded-in corner. The conflict resolution engine 302 can identify the conflicts between graphical effects and resolve the conflicts by selectively deactivating one or more of the conflicting graphical effects and changing any values related to the conflicting graphical effects as appropriate; one or more of the conflicting graphical effects are removed from the set of activated graphical effects. For example, if two effects conflict, either one of them is removed. In some implementations, possible conflicts between graphical effects are identified based on the layout rules, and the selection of which effect to remove in the case of a conflict can be based on graphical effect precedence rules specified in the layout rules (e.g., the top-right folded-in corner has precedence over the bottom-right folded-in corner). Referring back to the folded-in corner and slide frame example above, to resolve the conflict, the conflict resolution engine 302 can deactivate the folded-in corner in the icon style. The deactivation can be saved to the icon style, changing the icon style, or be a one-time deactivation effective for the particular thumbnail 310.

The composition engine 308 generates an icon 314 using the layout, by combining the thumbnail and graphical elements corresponding to the applied/active (e.g., non-filtered) graphical effects. In some implementations, the composition engine 308 composites the thumbnail and the graphical elements into the icon 314. In some implementations, the composition engine 308 adds the graphical elements to a thumbnail layer by layer.

The composition engine 308 also generates icon metadata 316 associated with the icon 314 and the layout. The icon metadata 316 stores various data related to the icon. In some implementations, the icon metadata 316 stores data regarding the positioning of the thumbnail and each graphical element in the icon. For example, the icon metadata 316 can include, for a thumbnail or an element in the icon, the layer and the coordinates in that layer at which the thumbnail or element is located. An item viewing module can use the metadata when presenting the icon to isolate or extract the thumbnail for further processing, such as rescaling the thumbnail, without distorting the graphical elements in the icon.

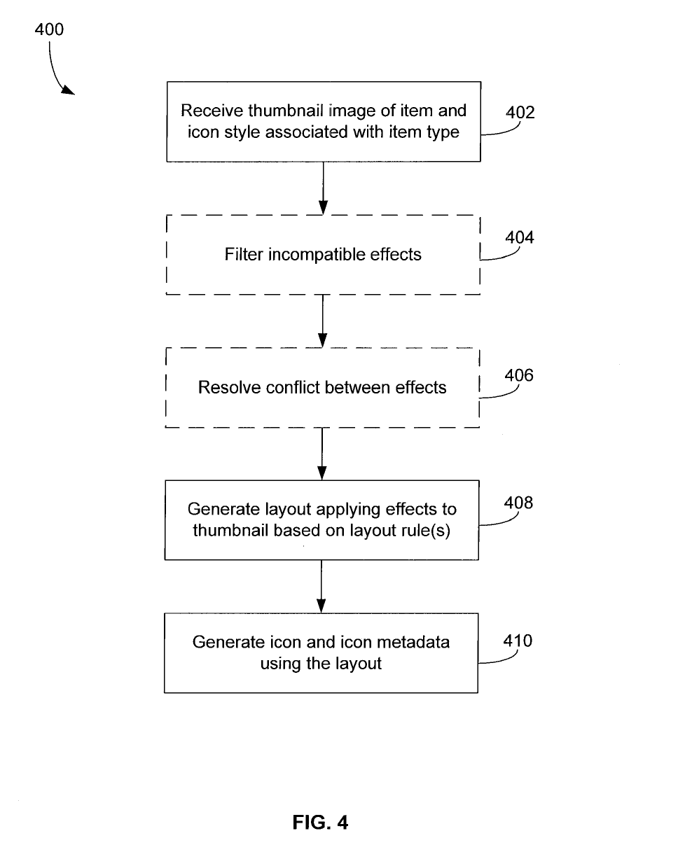

FIG. 4 is a flow diagram 400 illustrating an example process for generating icons for data items. For convenience, the process 400 is described in reference to an architecture 300 for performing the process 400.

A thumbnail of a data item and one or more icon styles associated with a type of the data item are received (402). The architecture 300 receives the thumbnail and the icon styles for processing by the engines 302-308 in the architecture 300. An icon style can indicate one or more graphical effects to be applied to the thumbnail. An icon style is read and the graphical effects activated by an icon style are identified.

Optionally, incompatible graphical effects amongst the identified graphical effects are filtered out (404). The filtering engine 302 can filter out incompatible graphical effects from the graphical effects that were identified as activated by the activated by the icon style.

Optionally, conflicts between activated graphical effects are identified and resolved (406). The conflict resolution engine 304 can identify conflicts between the conflicting graphical effects and resolve the conflicts by selectively deactivating conflicting graphical effects and changing values related to the conflicting effects.

A layout applying the applied/active graphical effects to the thumbnail is generated based on one or more layout rules (408). For example, the layout engine 306 can generate a layout that applies the activated graphical effects to the thumbnail. The generation of the layout can include combining or adding one or more graphical elements corresponding to the graphical effects to the thumbnail. In some implementations, the elements and the thumbnail are combined layer by layer.

An icon and icon metadata associated with the icon can be generated using the layout (410). The composition engine 308 composites the thumbnail and the graphical elements corresponding to the graphical effects in the layout. In some implementations, the composite of the thumbnail and the graphical elements are rendered into an icon suitable for presentation on a user interface. The icon can be stored as a data object (e.g., an image file) within the computer 100 (e.g., in local storage 106). The composition engine 308 also can generate metadata associated with the icon and the layout. For example, the metadata can describe the locations (e.g., layer and position coordinates in the layer) of the thumbnail and elements in the layout.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims.

1. A method comprising:
obtaining an image representing an item;
obtaining input specifying one or more styles;
for a style, identifying one or more graphical effects based on the style;
generating a layout including applying the style including the graphical effects to the image based on one or more layout rules;
generating a graphical representation corresponding to the item using the layout; and
generating metadata associated with the layout, the metadata including data indicating a location of the image in the layout.

2. The method of claim 1, wherein the item is associated with an item type; and the one or more styles are associated with the item type.

3. The method of claim 1, further comprising extracting the image from the graphical representation using the metadata.

4. The method of claim 1, wherein applying a graphical effect comprises layering the image and one or more graphical elements corresponding to the applied graphical effect.

5. The method of claim 4, wherein generating the graphical representation corresponding to the item using the layout comprises compositing the graphical elements and the image.

6. The method of claim 4, wherein the metadata further comprises data indicating a location of a respective graphical element in the layout.

7. The method of claim 1, wherein identifying one or more graphical effects based on the style comprises:
identifying one or more incompatible graphical effects from the identified graphical effects; and
removing the incompatible graphical effects from the identified graphical effects.

8. The method of claim 1, wherein identifying none or more graphical effects based on the style comprises:
identifying a conflict between two or more of the identified graphical effects; and
resolving the conflict, including removing a conflicting graphical effect from the identified graphical effects.

9. The method of claim 1, wherein the input specifying one or more styles comprises a bit field associated with a respective style, the bit field specifying one or more graphical effects.

10. A computer program product, encoded on a computer-readable medium, operable to cause a data processing apparatus to perform operations comprising:
obtaining an image representing an item;
obtaining input specifying one or more styles;
for a style, identifying one or more graphical effects based on the style;
generating a layout including applying the style including the graphical effects to the image based on one or more layout rules;
generating a graphical representation corresponding to the item using the layout; and
generating metadata associated with the layout, the metadata including data indicating a location of the image in the layout.

11. The computer program product of claim 10, wherein the item is associated with an item type; and the one or more styles are associated with the item type.

12. The computer program product of claim 10, wherein the operations further comprise extracting the image from the graphical representation using the metadata.

13. The computer program product of claim 10, wherein applying a graphical effect comprises layering the image and one or more graphical elements corresponding to the applied graphical effect.

14. The computer program product of claim 13, wherein generating the graphical representation corresponding to the item using the layout comprises compositing the graphical elements and the image.

15. The computer program product of claim 13, wherein the metadata further comprises data indicating a location of a respective graphical element in the layout.

16. The computer program product of claim 10, wherein identifying one or more graphical effects based on the style comprises:
identifying one or more incompatible graphical effects from the identified graphical effects; and
removing the incompatible graphical effects from the identified graphical effects.

17. The computer program product of claim 10, wherein identifying one or more graphical effects based on the style comprises:
identifying a conflict between two or more of the identified graphical effects; and
resolving the conflict, including removing a conflicting graphical effect from the identified graphical effects.

18. The computer program product of claim 10, wherein the input specifying one or more styles comprises a bit field associated with a respective style, the bit field specifying one or more graphical effects.

19. A system, comprising:
one or more processors; and
instructions configured for execution by the one or more processors, the instructions comprising instructions to:
obtain an image representing an item; ’obtain input specifying one or more styles;
for a style, identify one or more graphical effects based on the style;
generate a layout including applying the style including the graphical effects to the image based on one or more layout rules;
generate a graphical representation corresponding to the item using the layout; and
generate metadata associated with the layout, the metadata including data indicating a location of the image in the layout.

20. A system, comprising:
means for obtaining an image representing an item;
means for obtaining input specifying one or more styles;
means for identifying, for a style, one or more graphical effects based on the style;
means for generating a layout including applying the style including the graphical effects to the image based on one or more layout rules;
means for generating a graphical representation corresponding to the item using the layout; and
means for generating metadata associated with the layout, the metadata including data indicating a location of the image in the layout.
